(19) United States
(12) Patent Application Publication
(10) Pub. No.: US 2011/0164471 A1
(43) Pub. Date: Jul. 7, 2011

(54) INTEGRATED WIRELESS POWER SYSTEM

(75) Inventors: David W. Baarman, Fennville, MI (US); Sean T. Eurich, Holland, MI (US); William T. Stoner, JR., Ada, MI (US)

(73) Assignee: ACCESS BUSINESS GROUP INTERNATIONAL LLC, Ada, MI (US)

(21) Appl. No.: 12/983,998

(22) Filed: Jan. 4, 2011

Related U.S. Application Data
(60) Provisional application No. 61/292,380, filed on Jan. 5, 2010.

(51) Int. Cl. G04B 47/00; H02J 17/00

(52) U.S. Cl. 368/10; 307/104

(57) ABSTRACT

The present configuration provides an integrated wireless power system for powering or charging a portable device. The integrated wireless power system includes 1) an integrated wireless power appliance that both provides power as well as additional functionality, such as timekeeping, radio, and alarm functionality and 2) a portable device capable of receiving wireless power from the integrated wireless power appliance.

### BACKGROUND OF THE INVENTION

The present invention relates to integrated appliance chargers where a charging system for charging one or more portable devices is integrated into a consumer appliance to provide additional functionality to the consumer appliance.

Many portable devices require a wired connection and separate electronics to charge their batteries. For example, a corded wall wart is often used to supply power from a wall outlet directly to a portable device. It can be inconvenient for a user to have to plug the wall wart into the wall outlet and into the portable device. One solution to using a discrete charger, such as a wall wart, is to integrate the charging electronics into an appliance so that the user need only connect their portable device to the existing appliance. These conventional integrated appliances help disguise unsightly charging equipment. For example, the Homedics® Alarm Clock Radio with iPod® Docking Station provides such a platform.

Within a conventional integrated charging system, electrical power is transferred to the portable device through a connector that plugs into a power port on the portable device. The design of the connector and conventional system, including power specifications and plug configurations, typically vary from device to device such that a conventional integrated charger in one appliance can only be used to charge a particular device. Many conventional integrated chargers cannot function properly with multiple device configurations or multiple power requirements. Accordingly, a user of multiple portable devices must maintain discrete conventional integrated charging systems for each portable device.

One problem that arises in conventional integrated chargers is that the portable device can inadvertently inject unwanted signal noise into the appliance. Some conventional integrated chargers include a radio receiver and are particularly susceptible to this problem. A portable phone utilized with the conventional system broadcasts signals that are injected into the radio receiver and subsequently heard from the speaker. The result is that a person using the conventional charger in proximity to a portable device cannot listen to the radio without hearing unwanted interference. This interference can occur even while the portable device is not actively in use by a user, because the portable device may be communicating in the background.

Users of portable devices often are forced to carry portable chargers with them at times when they will be out of range of their normal charging location for a longer duration than the battery life of their portable device. It can be inconvenient and burdensome to carry chargers for multiple portable devices. To overcome this inconvenience, some temporary residences supply an integrated charging appliance solution to their residents. However, the problem with device configuration and power specifications remains the same. Conventional integrated charging appliances are designed to accommodate a single device standard, and a portable device user will not know whether their device will be compatible with a temporary residence's solution. As a result, the portable device user must still transport their device specific charging system.

### SUMMARY OF THE INVENTION

The present invention provides an integrated wireless power system for powering or charging a portable device. The integrated wireless power system includes 1) an integrated wireless power appliance that both provides power as well as additional functionality, such as timekeeping, radio, and alarm functionality and 2) a portable device capable of receiving wireless power from the integrated wireless power appliance.

In one embodiment, the consumer appliance may be a clock radio. The portable device may receive and transmit various signals, which can cause interference in the integrated wireless power appliance while in close proximity. Some of the interference may be reduced by shielding certain components in the integrated wireless power appliance. However, in appliances that utilize external communication, it may be difficult to utilize shielding to reduce the interference effectively without also reducing the quality or ability for external communication.

The integrated wireless power appliance may reduce the interference from the portable device by generating an inverted and scaled signal corresponding to the portable device signal and using the scaled and inverted signal to cancel that portion before its output by the integrated wireless power appliance. The interference cancellation may be used in combination with selected shielding to reduce the overall effect of interference produced by the portable device.

The present invention provides a charging system that integrates into commonly used consumer appliances. Because the integrated charging system provides a platform to charge multiple portable devices without the need for different charging platforms, a user is liberated from having to transport multiple types of equipment from place to place. A residence may include an integrated wireless power system so that a user does not have to worry about carrying equipment or where to charge their device. The integrated system allows residences to easily and quickly modify their furnishings without costly upgrades.

These and other objects, advantages, and features of the invention will be more fully understood and appreciated by reference to the description of the current embodiment and the drawings.

### BRIEF DESCRIPTION OF THE DRAWINGS

FIG. 1 is a block diagram of an integrated wireless power system including an integrated wireless power appliance with interference cancellation and a remote device.

FIG. 2 is a block diagram of an integrated wireless power system.

FIG. 3a is a representative perspective view of an integrated wireless power system.

FIG. 3b is a representative front view of the integrated wireless power system.

FIG. 4a is a representative perspective view of an alternative embodiment of the integrated wireless power system.

FIG. 4b is a representative front view of the FIG. 4a embodiment of the integrated wireless power system.

FIG. 5a is a representative perspective view of an alternative embodiment of the integrated wireless power system..

FIG. 5b is a representative front view of an alternative embodiment of the integrated wireless power system.

FIG. 6a is a representative perspective view of an alternative embodiment of the integrated wireless power system.

FIG. 6b is a representative front view of an alternative embodiment of the integrated wireless power system.

FIG. 7a is a representative perspective view of an alternative embodiment of the integrated wireless power system.

FIG. 7b is a representative front view of an alternative embodiment of the integrated wireless power system.

FIG. 8 is a representative perspective view of an alternative embodiment of the integrated wireless power system.

FIG. 9 is a block diagram of one embodiment of a system for interference cancellation.

FIG. 10 is a block diagram of an alternative embodiment of a system for interference cancellation.

FIG. 11 is a block diagram of an alternative embodiment of a system for interference cancellation.

### DESCRIPTION OF THE CURRENT EMBODIMENT

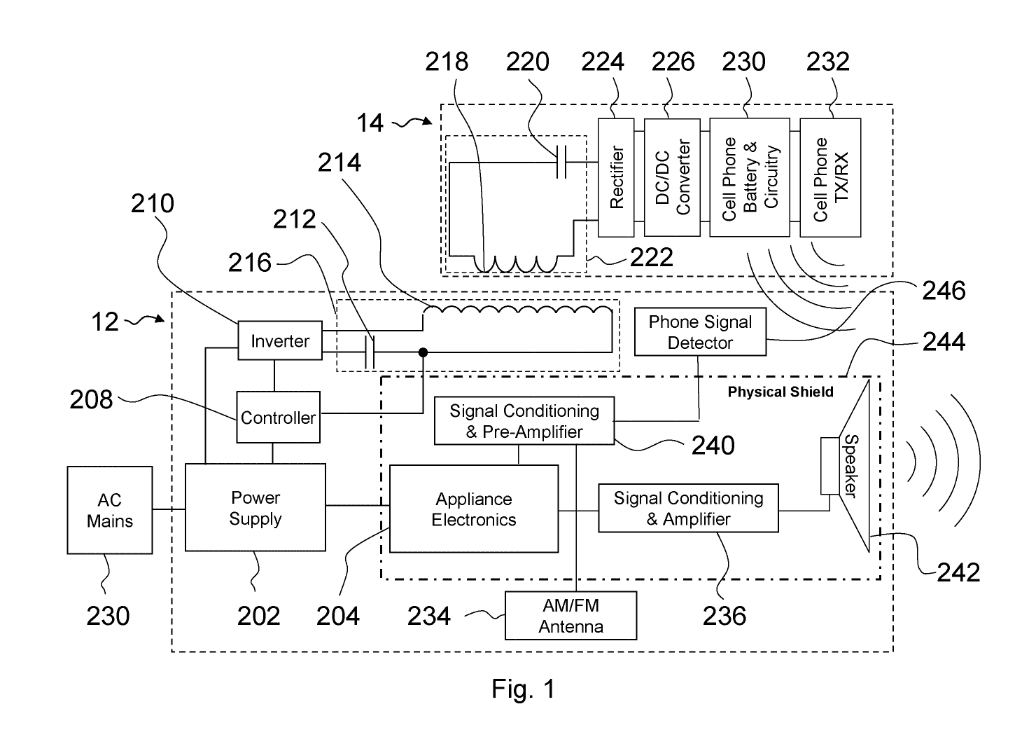

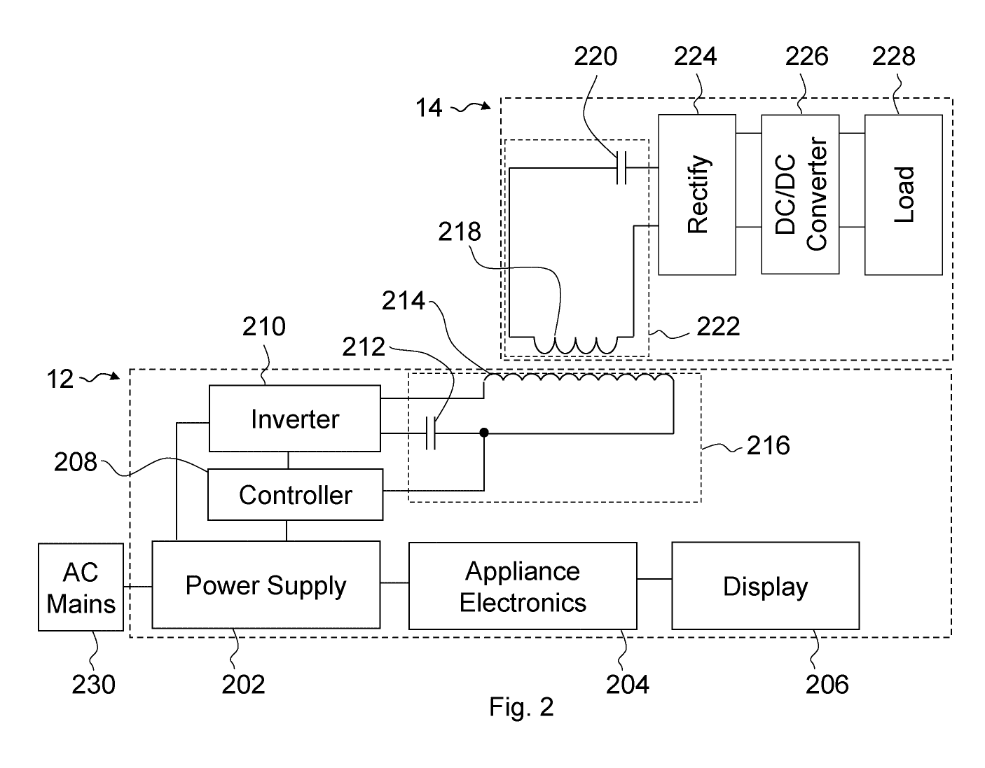

An integrated wireless power system in accordance with an embodiment of the present invention is shown in FIG. 1. The integrated wireless power system includes an integrated wireless power appliance 12 and a remote device 14 capable of receiving wireless power. The integrated wireless power system of FIG. 1 includes interference cancellation circuitry. FIG. 2 shows an alternative embodiment of an integrated wireless power system that is somewhat similar to the integrated wireless power system of FIG. 1, but does not include any interference cancellation circuitry.

In some embodiments, the integrated wireless power appliance 12 is specifically adapted for use in a residence. For example, the integrated wireless power appliance may be located within a residence such as a household, hotel, motel, bed and breakfast, dormitory. The residence may have multiple users over time, each with separate portable devices 14. The integrated wireless charging apparatus may include wireless power supply circuitry such that a residence does not require a charging system for each user device. Instead, the integrated wireless charging apparatus 12 provides wireless charging for a variety of different remote devices. The integrated wireless charger saves space in the residence and adds to the aesthetic appeal. In addition, the integrated wireless power appliance 12 may replace an appliance typically found in a residence, such as a timekeeping device like a clock or a combination clock/radio or a personal computer, television, DVD player, cable box, automobile console, or a tabletop device. This list is not exhaustive and those in the art will understand that the invention could be integrated into many other consumer appliances.

Integration of wireless charging into an appliance already located within a residence provides a number of advantages. For example, a hotel may desire to provide wireless charging to its patrons, but it may be difficult to justify the additional purchase of a separate wireless charger. However, replacing the traditional clock/radio in a hotel room with an integrated wireless charging clock/radio will allow the hotel to provide a wireless charging hot spot without having to provide an additional apparatus. Further, because the wireless integrated charging apparatus can provide power wirelessly to a variety of different remote devices, some of the incompatibility issues with conventional contact integrated chargers are addressed.

Referring to the illustrated embodiment of FIG. 2, the portable device 14 may include a secondary wireless power receiver 222, a rectifier 224, and DC/DC converter 226 and a load 228. The load 228 may include cell phone battery and other cell phone related circuitry 230 as well as a cell phone transceiver 232, as shown in the FIG. 1 embodiment where the portable device is a cellular telephone. In the current embodiment, the secondary wireless power receiver includes a secondary coil 218 and may include a secondary tank capacitor 220.

The portable device 14 may have capabilities, as discussed below, to allow it to interact with the integrated wireless charging apparatus 12. For example, the secondary wireless receiver 222 provides the portable device 14 with the capability to receive power without a physical connection to a power supply. Further, the integrated wireless charging apparatus 12 may interact with a variety of portable devices 14, in some embodiments this interaction may take place simultaneously.

The integrated wireless power appliance 12 of FIG. 2 generally includes a power supply 202, appliance electronics 204, a controller 208, an inverter 210, and a tank circuit 216 for supplying power to the portable device 14. The integrated wireless power appliance 12 may also include a display 206 to display information to a user. The appliance electronics 204 may include a variety of different electronic components related to the function of the appliance. For example, where the appliance is a clock/radio, the appliance electronics may include various components for operation of the clock and radio. Further, in some embodiments the appliance electronics 204 may include a user interface 32 to supply input to the integrated wireless power appliance.

The power supply 202 of the current embodiment may be capable of receiving power in one form and providing power to the controller 208, inverter 210, tank circuit 216, appliance electronics 204, and the display 206, if present. The power supply 202 may receive power in the form of DC or AC from an external supply. For example, the power supply 202 may be a conventional DC/DC converter or a combination of an AC rectifier and a DC/DC converter. The power supply 202 output may also include filters to reduce noise, improve load regulation, or another suitable reason. In addition, the power supply 202 may be capable of supplying different amounts of power to different components. For example, the integrated wireless power appliance 12 may include a display 206 and appliance electronics 204 that have separate power requirements, which the power supply 202 may provide separately to both.

The integrated wireless charging apparatus 12 generally includes a charging spot 30. The charging spot 30 may be associated with the tank circuit 214, which generates an electromagnetic field at the charging spot 30. When in the presence of the electromagnetic field, a portable device 14 may receive power wirelessly from the integrated wireless charging apparatus 12. A secondary wireless power receiver 222 within the portable device 14 receives the power generated by the integrated wireless charging apparatus 12 and delivers the received power in a usable form to the load 228.

In the current embodiment, the inductive power supply of the integrated charging system includes a tank circuit 216, an inverter 210, and a controller 208. The tank circuit 216 may include a primary 214 and a primary tank capacitor 212. The primary 214 may be a coil of wire. The characteristics of the primary coil 214 (e.g. wire size, wire type, number of turns, coil shape) will vary from application to application to achieve the desired functionality. The primary 214 may be essentially any component capable of generating an electromagnetic field. For example, the primary 214 may be replaced by a printed circuit board coil or a stamped coil, such as a printed circuit board coil incorporating the inventive principles of U.S. patent application Ser. No. 12/236,832, which is entitled “Printed Circuit Board Coil” and filed Sep. 24, 2008 by Baarman et al., and which is incorporated herein by reference in its entirety.

In one embodiment, the primary tank capacitor 212 of the illustrated embodiment is selected to have a capacitance that, when coupled with the primary coil 214, provides a primary tank circuit 216 with a resonant frequency at or near the anticipated range of operating frequencies. The characteristics of the tank capacitor 212 may vary from application to application, as desired.

The inverter 210 receives power from the power supply 202 and drives the primary tank circuit 216 with an AC signal. The inverter 210 transforms DC power from the power supply 202 into an AC signal. The inverter 210 may output an AC signal of various forms, including but not limited to sinusoidal, square, or other periodic waveforms. The inverter 210 may receive communication from the controller 208 that indicates changes to make to the AC signal's characteristics. Accordingly, the parameters of the AC signal, including the waveform, may be adjusted during operation. For example, the AC signal type, amplitude, frequency, and duty cycle may all be independently adjusted during operation. Alternatively, the inverter 210 may be capable of changing only one or a few characteristics of the AC signal. For example, the inverter 210 may only change amplitude or only change amplitude and frequency. The ability to change the characteristics of the AC signal output to the primary tank circuit 216 during operation enables the inductive power supply to efficiently transmit power wirelessly to portable devices 14 that have different power receiving characteristics.

The controller 208 is capable of directing the inverter 210 to change the AC signal to the primary tank circuit 216. The controller 208 may direct the inverter to change any one of signal type, amplitude, frequency, or duty cycle independently of the other during operation. This list is not exhaustive, but is illustrative of the possible characteristic changes. Alternatively, the controller 208 may be capable of directing the inverter 210 to change only one or a few AC signal characteristics.

The controller 208 may be capable of communicating desired changes in the AC signal to the inverter 210 based on one or more sensed characteristics of the primary tank circuit 216. In alternative embodiments, the controller may be connected to a receiver which is in communication with the portable device. In this alternative embodiment, the controller 208 may be capable of communicating desired changes in the AC signal to the inverter 210 based on information received from the portable device. Sensed characteristics include but are not limited to ambient level, amplitude, phase, or frequency. The controller 208 may have the capability to sense characteristics of the primary tank circuit 216 by monitoring current changes in the primary tank circuit 216. In the current embodiment, changes in current may be sensed by a current sense transformer inductively coupled to the primary tank circuit 216. The sensed characteristics may change based on attributes of the relationship between the primary tank circuit 216 and a secondary tank circuit 222, composed of secondary coil 218 and secondary tank capacitor 220, in the portable device 14. For example, the mutual inductance between the primary tank circuit 216 and the secondary tank circuit 222 may change because of the physical proximity between the primary coil 214 and the secondary coil 218, or because of a different secondary tank circuit 222 being used in combination with the primary tank circuit 216. Additionally, the sensed characteristics in the secondary tank circuit 222 may change as a result of passive or active variations in the association between the primary coil 214 and secondary coil 218. As an example, the portable device 14 may inadvertently move during charging, which results in a change in mutual inductance between the primary coil 214 and the secondary coil 218. The present invention may compensate for this change to achieve an effective power transfer between the integrated wireless power appliance 12 and the portable device 14. The sensed characteristics may also change because of changes in the appliance electronics 204. For example, the integrated wireless power appliance 12 may have an AM/FM Antenna 234 that may cause interference with the power transfer between the integrated charging system and the portable device 14. The controller 208 may sense these changed characteristics and properly adapt the signal to achieve efficient power transfer.

The controller 208 may include a microcontroller, external clock, external memory, and other associated supporting electronics. The controller 208 includes the capacity to receive sensed information and communicate AC signal changes to the inverter 210. The controller 208 may have the ability to communicate information to the inverter 210 via any number of methods, including but not limited to control lines, a communication bus, or analog signals. Control lines may be conventional 5V/3.3V logic signals or any logic level necessary to communicate with the inverter 210. Alternatively, the controller 208 may communicate with the inverter via a communication bus such as I2C or SPI. As another alternative, the controller 208 may utilize analog signals to communicate changes to the inverter 210, where a particular signal level notifies the inverter 210 of the appropriate characteristic.

Alternatively, the controller 208 may not include a microcontroller, but rather includes an analog circuit capable of communicating desired AC signal changes to the inverter 210. The analog circuit may sense characteristics in the primary tank circuit 216 and direct the inverter 210 to make changes in the AC signal to attain an appropriate power transmission between the inductive power supply and the portable device 14.

The inductive power supply described above may include essentially any circuitry capable for supplying an AC signal to the primary coil 214. it may be desirable to use an inductive power supply including the resonant seeking circuit of the inductive power supply system disclosed in U.S. Pat. No. 6,825,620, which is entitled “Inductively Coupled Ballast Circuit” and issued Nov. 30, 2004, to Kuennen et al; the adaptive inductive power supply of U.S. Pat. No. 7,212,414, which is entitled “ Adaptive Inductive Power Supply” and issued May 1, 2007, to Baarman; the inductive power supply with communication of U.S. Pat. No. 7,522,878 which is entitled “Adaptive Inductive Power Supply with Communication” and issued Apr. 21, 2009 to Baarman; the inductive power supply for wirelessly charging a LI-ION battery of U.S. Ser. No. 11/855,710, which is entitled “System and Method for Charging a Battery” and filed on Sep. 14, 2007 by Baarman; the inductive power supply with device identification of U.S. Ser. No. 11/965,085, which is entitled “Inductive Power Supply with Device Identification” and filed on Dec. 27, 2007 by Baarman et al; or the inductive power supply with duty cycle control of U.S. application Ser. No. 12/349,840, which is entitled “Inductive Power Supply with Duty Cycle Control” and filed on Jan. 7, 2009 by Baarman—all of which are incorporated herein by reference in their entirety.

In the current embodiment, the integrated wireless power appliance 12 may include appliance electronics 204. The appliance electronics 204 may be essentially any circuitry related to the function of the appliance. For example, the appliance electronics in a clock may be timekeeping electronics capable of tracking time and administering an alarm as is well known in the art. Further, the timekeeping electronics may have user interface controls 32 that are capable of communicating with the timekeeping electronics. The timekeeping electronics may include the ability to communicate information to a display 206. The display may be of any type as known in the art. For example, an LCD or LED display may be used.

In the illustrated embodiment of FIG. 1, the integrated wireless power appliance 12 may include features similar to the previous embodiment and further include radio electronics for receiving and playing radio broadcasts, such as FM and AM signals. In this embodiment, the integrated wireless power appliance 12 includes an AM/FM antenna 234, a phone signal detector 246, signal conditioning and amplifier 236, signal conditioning and pre-amplifier 240, speaker 242, and shielding 244 for interference suppression. The interference may include phone signals such as GSM, CDMA, 3G, 4G, WiMax, and others that may be costly to filter from close proximity devices using shielding alone. The AM/FM antenna 234 and speaker 242 components are well known in the art and therefore will not be described in detail.

A phone signal detector 244 is capable of detecting transmissions from the portable device 14, including transmissions from cell phone transceiver 232. In one embodiment, the phone signal detector 244 may include a dedicated antenna capable of receiving transmissions from the cell phone transceiver 232. Alternatively, in a different embodiment, the phone signal detector 244 may be integrated into other components that may detect transmissions from the cell phone receiver 232, such as the AM/FM antenna 234. The phone signal detector 244 may also be capable of detecting and receiving transmissions from multiple portable devices 14.

The signal conditioning pre-amplifier 240 included in the current embodiment may have the capability to receive information from the phone signal detector 244 and the AM/FM antenna 234. The signal conditioning pre-amplifier 240 may appropriately scale the signal from the phone signal detector 244 and invert it. The signal conditioning pre-amplifier 240 may also appropriately scale the signal from the AM/FM antenna 234, where the signal from the AM/FM antenna 234 is a composite signal comprising components of the cell phone transceiver 232 signal and AM/FM transmissions. The signal conditioning pre-amplifier 240 also includes the capability to superimpose the scaled-inverted signal from the phone signal detector 244 with the AM/FM scaled signal from the AM/FM antenna 234. The resulting signal is a cleaner signal transmissions from the portable device 14 that is in close proximity to the integrated wireless power appliance 12. A cleaner signal generally refers to a signal where some amount of interference has been removed. The signal conditioning pre-amplifier 240 may also include the capability of producing a signal with reduced interference when the phone signal detector 244 provides a signal comprising transmissions from multiple portable devices 14.

The signal conditioning and amplifier 236 includes the ability to demodulate the cleaner signal produced from the signal conditioning and pre-amplifier 240 into a cleaner audio signal than otherwise would have been produced without the interference cancellation. The signal conditioning and amplifier 236 may also amplify the cleaner audio signal and drive the speaker 242. The resulting sound from the speaker 242 is a cleaner audio signal with reduced interference from the portable device 14.

In the current embodiment, the timekeeping device includes shielding 244 around the appliance electronics 204, signal conditioning and pre-amplifier 240, signal conditioning and amplifier 235, and speaker 242. The shielding 244 reduces some interference from the remote device.

In an alternative embodiment, the appliance electronics 204 may have a transceiver for bi-directional communication with the portable device 14. The transceiver circuitry may be capable of communicating wirelessly with the portable device 14 via well-known protocols such as IEEE 802.11 or Bluetooth®. The present invention is not limited to these protocols, rather they are provided as examples of wireless communication protocols.

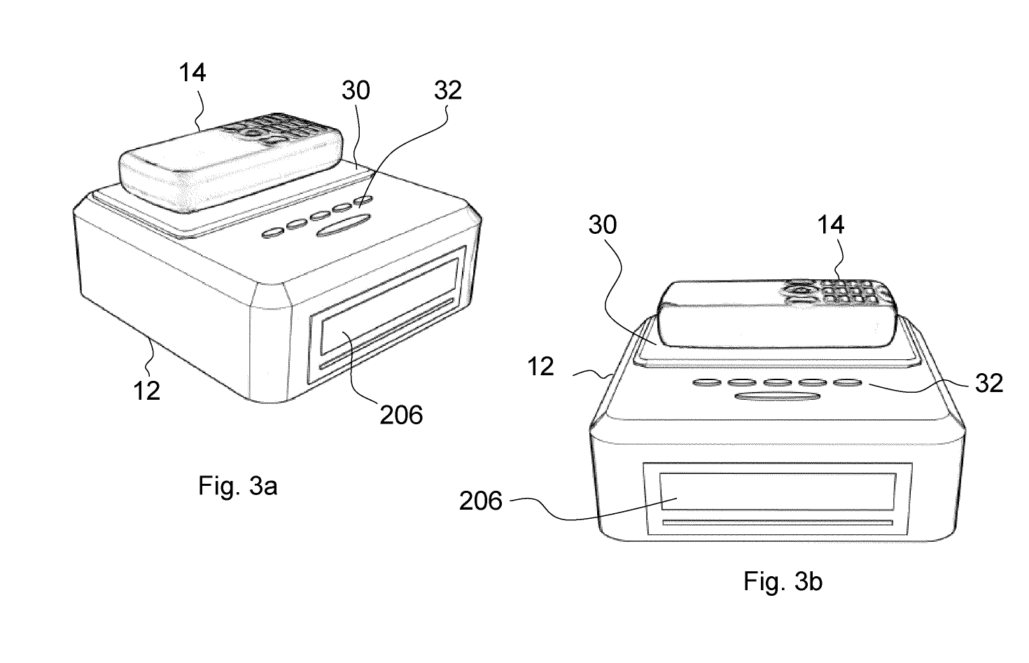

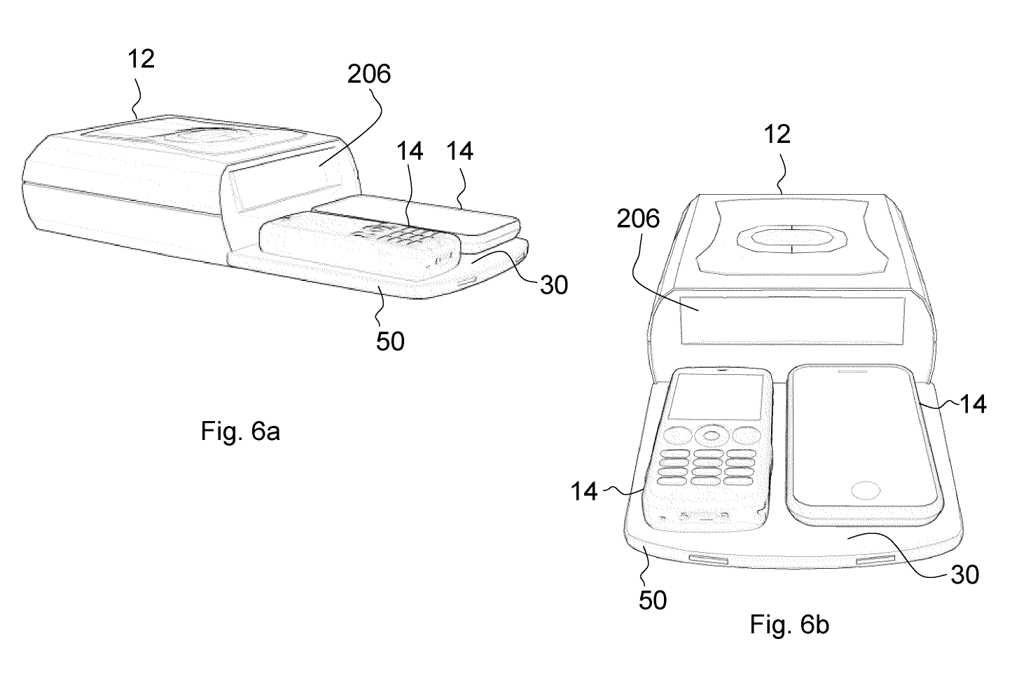

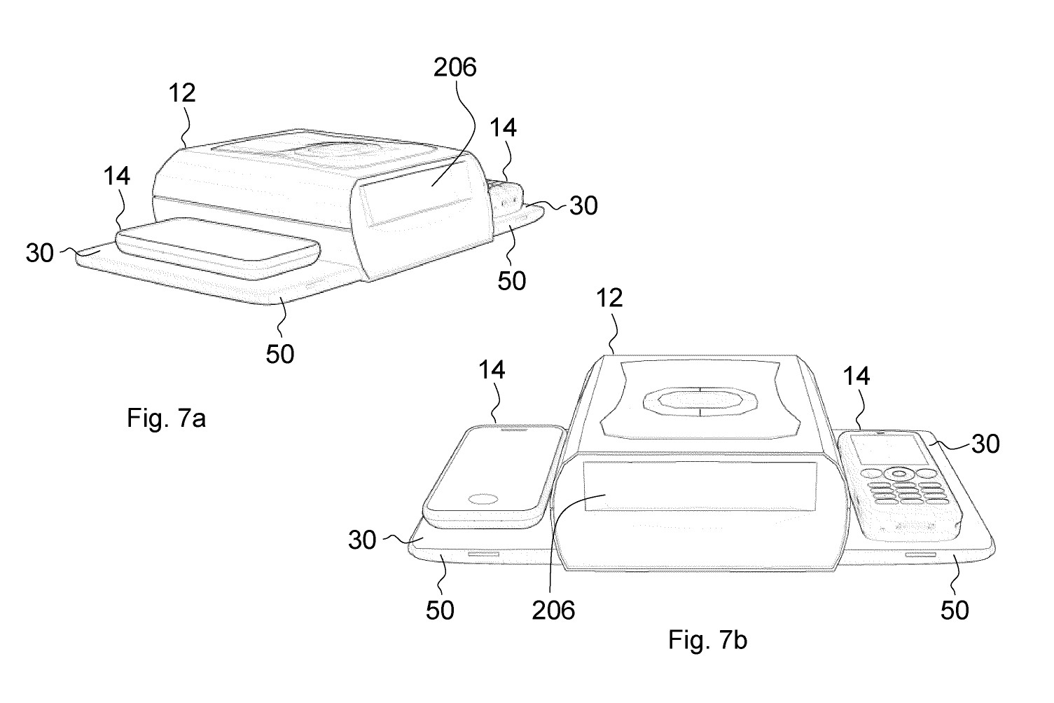

In the illustrated embodiments of FIG. 3a-8, the charging spot 30 may be located in any number of positions on the integrated wireless power appliance 12, and may be appropriately sized to fit one or multiple portable devices 14. Moreover, the charging spot 30 may be associated with one or more primary coils 214 for charging portable devices 14. Charging spots 30 may be the surfaces and charging locations disclosed in U.S. patent application Ser. No. 12/339,512, which is entitled “Improvements Relating to Retention of Rechargeable Devices” and filed Dec. 19, 2008, to Beart; and the charging locations of U.S. patent application Ser. No. 12/339,509 to, which is entitled “Improvements Relating to Contact-Less Power Transfer” and filed Dec. 19, 2008, to Cheng—all of which are incorporated herein by reference in their entirety.

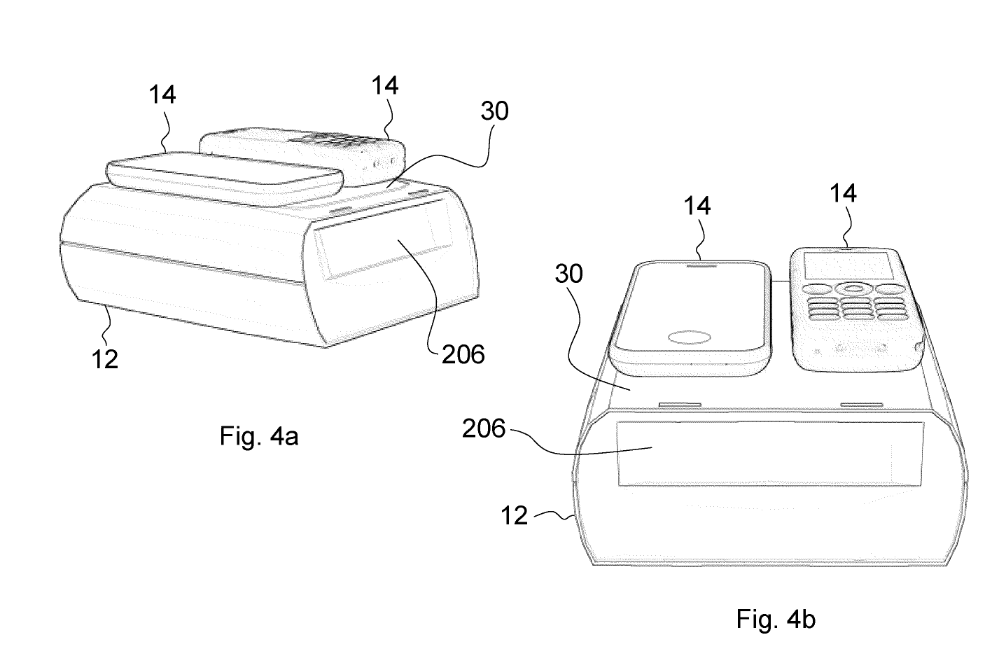

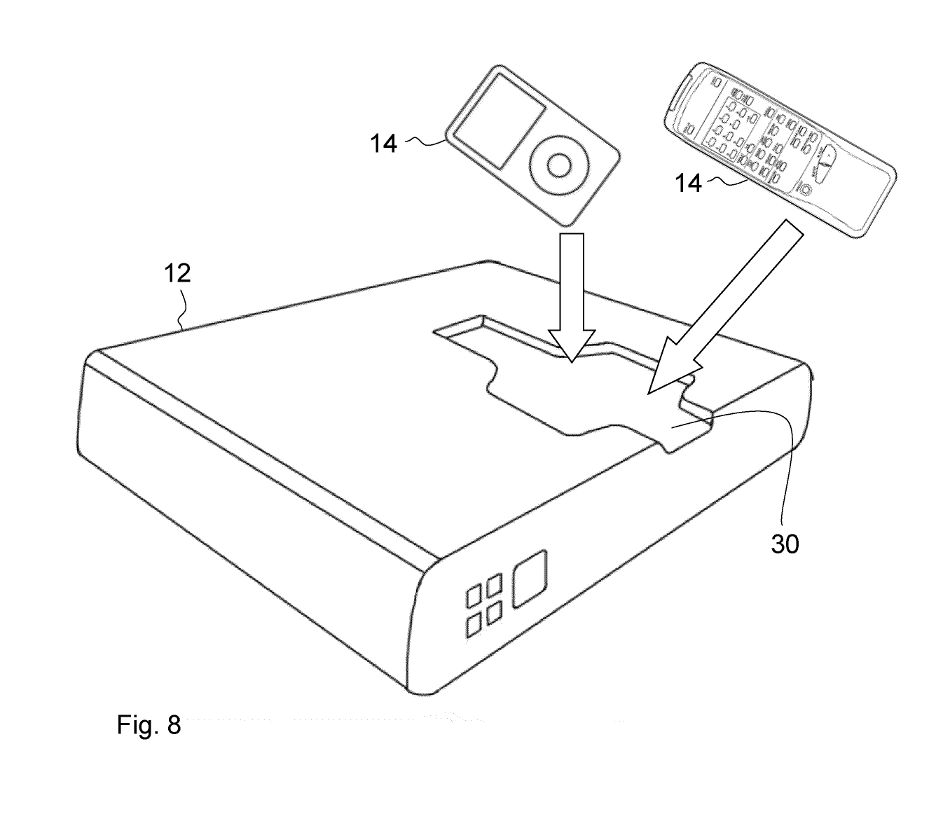

The illustrated embodiments of FIGS. 3a and 3b show the charging spot 30 located on the upper surface of the integrated wireless power appliance 12 covering only a portion of the surface. However, the integrated wireless power appliance 12 may include one or more charging spots 30, located in the same area of the device or at different areas, for charging multiple portable devices 14 at one time. In alternative embodiments, for example as shown in FIGS. 4a, 4b, and 8, the charging spot 30 may be located across an entire surface of the integrated wireless power appliance 12, or may form a cavity within the integrated wireless power appliance 12 suitable for holding multiple portable devices 14.

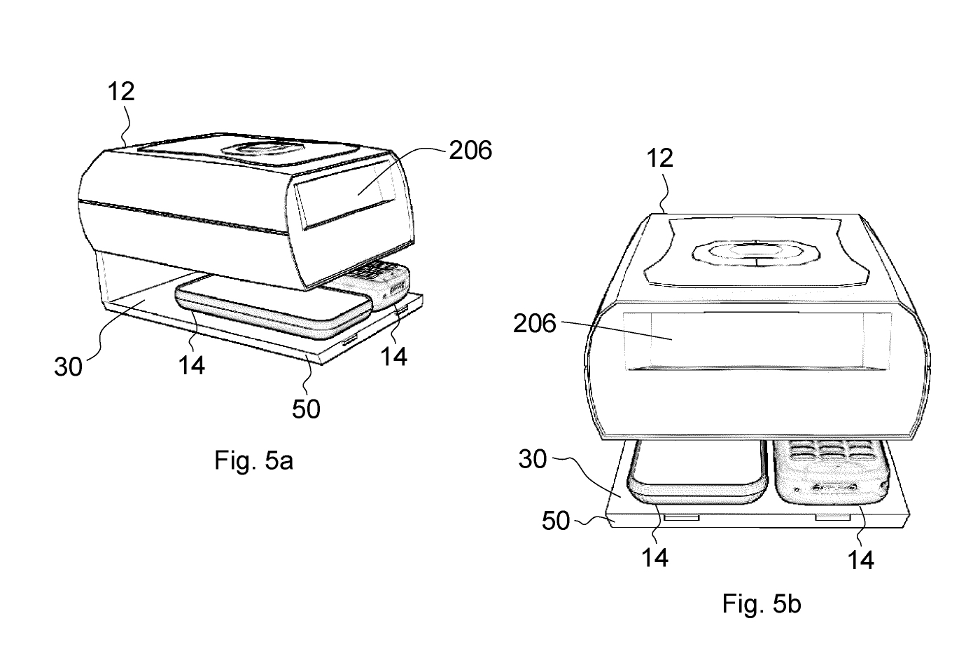

In the illustrated embodiments of FIG. 5a-7b, the integrated wireless power appliance 12 may have a platform 50 extending from its main body. The platform 50 may extend from any side or may be underneath the integrated wireless power appliance 12 and have supporting structure to buttress the integrated wireless power appliance 12 above the platform 50. The platform 50 may support one or more portable devices 14 and may have one or more charging spots 30. Additionally, there may be more than one platform 50 extending from the integrated wireless power appliance 12.

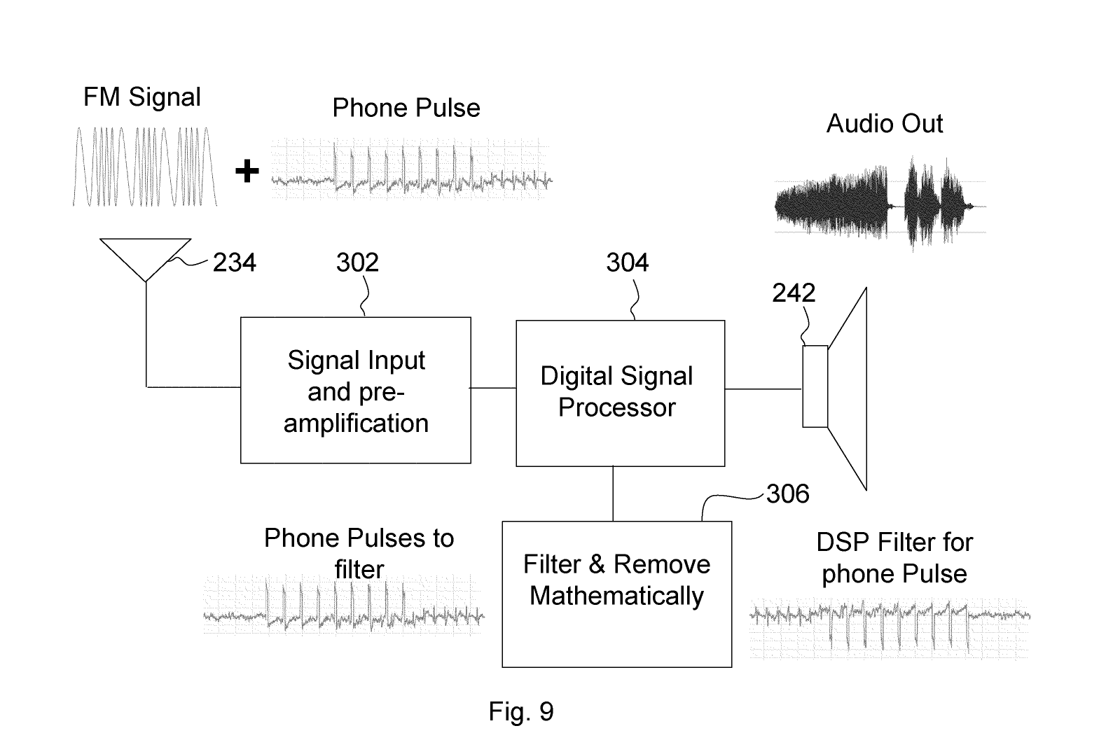

In the illustrated embodiments of FIG. 9-11, the integrated wireless power appliance 12 may include components capable of removing portable device 14 interference from an AM/FM modulated signal received in an AM/FM antenna 234. In the illustrated embodiments, the AM/FM antenna 234 receives a noisy signal that includes interference from a portable device 14. The interference, as discussed above, may be from various types of phone signals, including GSM.

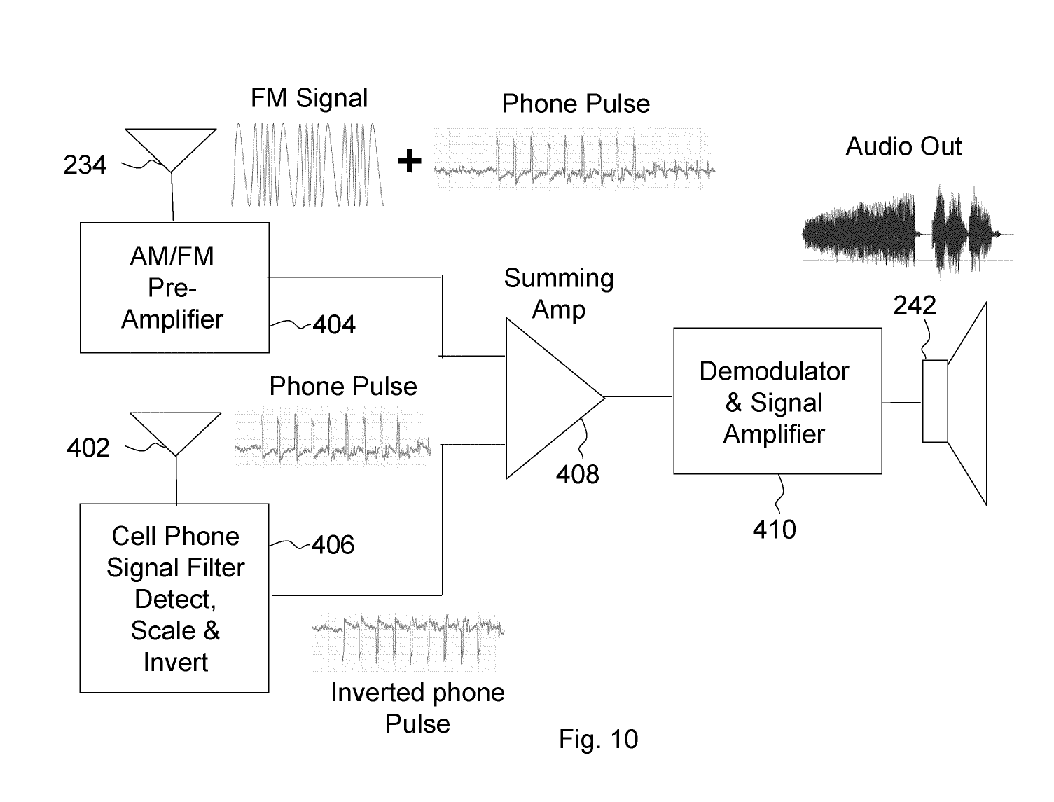

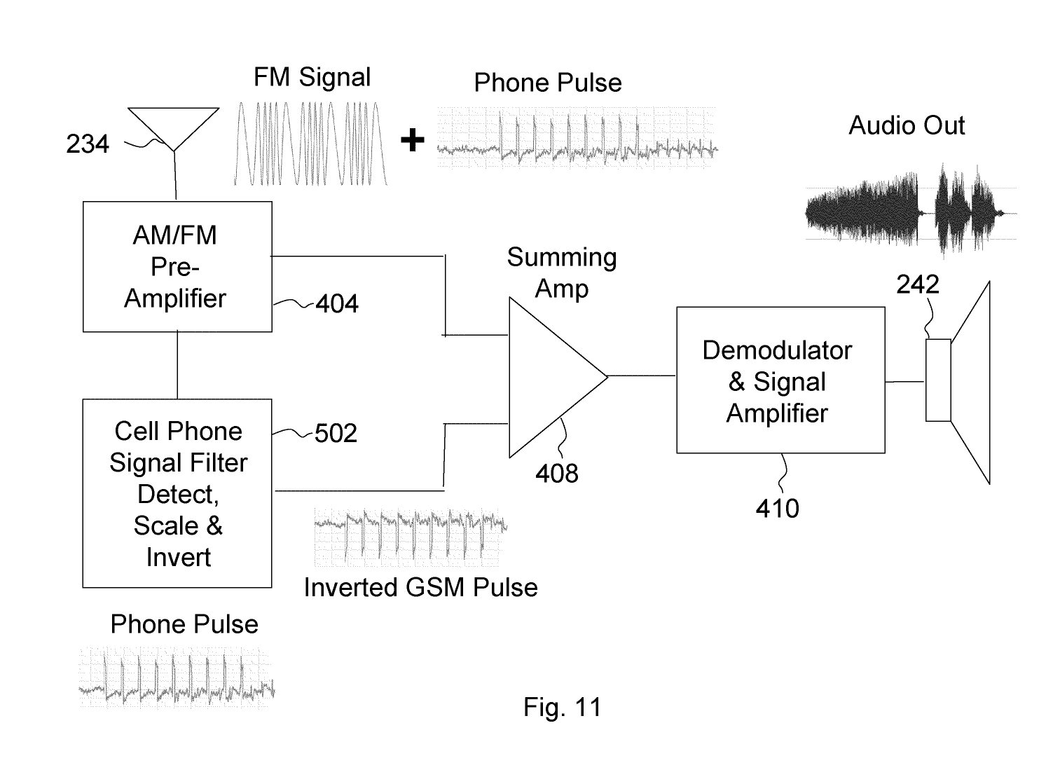

With reference to FIGS. 10 and 11, an AM/FM pre-amplifier 404 receives a noisy signal from the AM/FM antenna 234, and a cell phone signal filter detect, scale, and invert 406 receives an interference signal through the antenna 402. The phone signal filter detect, scale, and invert 406 includes the ability to properly scale and invert the interference signal when it is present. The summing amp 408 combines the output signals from the AM/FM pre-amplifier 404 and cell phone signal filter, detect, scale, and invert 406 to form an output signal for demodulation and amplification. The resulting output signal does not include the interference signal received by the AM/FM antenna 234. The demodulator and signal amplifier 410 then produces a cleaner audio signal from the output signal and drives the speaker 242. Rather than using two antennas, the embodiment of FIG. 11 may have a cell phone filter, detect, scale, and invert 502 that is capable of figuring out the interference signal from the noisy signal. The remaining functionality is similar to the embodiment shown in FIG. 10.

FIG. 9 includes components for producing a similar result. However, the embodiment of FIG. 9 utilizes digital signal processing to remove the interference signal from the noisy signal received by the AM/FM antenna 234. The filter and remove mathematically 306 component may receive the interference signal from a separate antenna or it includes the capability to figure out the interference signal from the noisy signal supplied by the AM/FM antenna 234. The digital signal processor 304 then removes the interference signal and drives the speaker 242 with a cleaner audio signal.

In alternative embodiments, the present invention may include a magnetic positioning system for the integrated wireless power appliance 12 where a primary magnet is positioned in the approximate center of the primary coil 214 and another secondary magnet is positioned in the approximate center of the secondary coil 218. The primary magnet and primary coil 214 may be associated with a particular charging spot 30 of the integrated wireless power appliance 12. The primary and secondary magnets are oriented to attract one another to properly align the primary coil 214 and secondary coil 218 with respect to one another. The magnets are also sufficiently non-conductive in the presence of an electromagnetic field to reduce undesired heat within the magnets. The magnets may be permanent or temporary such that a portable device 14 may be captured and released at different times. For example, the portable device 14 and integrated wireless power appliance 12 may utilize temporary magnets that attract each other during a charging cycle and release when the cycle has finished. As another example, the magnetic positioning system disclosed in U.S. patent application Ser. No. 12/390,178, which is entitled “Magnetic Positioning for Inductive Coupling” and incorporated herein by reference in its entirety, may be utilized in the present invention.

Alternatively, the primary coil 214 may move within the charging spot 30. The primary coil 214 may closely align itself with the secondary coil 218 when the portable device 14 is within range of the charging spot 30. After the portable device 14 is removed from the charging spot 30, the primary coil 214 may be capable of returning to a home position. Further, the charging spot 30 may have markings that indicate the primary coil's 214 home position. For example, the moveable magnet system disclosed in U.S. application Ser. No. 12/652,077, which is entitled “Inductive Power Supply,” and filed Jan. 5, 2010 to Stoner et al.; and U.S. application Ser. No. 12/652,053, which is entitled “Wireless Charging System with Device Power Compliance,” and filed Jan. 5, 2010 to Baarman et al.—both of which are incorporated by reference in their entirety.

In alternative embodiments, the integrated wireless power appliance 12 may include a plurality of primary tank circuits 216 for separately charging multiple portable devices 14.

In another aspect, the present invention may communicate with the portable device 14 through the electromagnetic field generated by the integrated charging system. The portable device 14 and the integrated wireless power appliance 12 may each communicate through the primary and secondary coils, 214 and 218 respectively, as the portable device 14 is simultaneously being charged. The integrated wireless power appliance 12 may enable communication by modulating a data signal over the electromagnetic field. The portable device 14 may then be capable of demodulating the modulated data signal and extracting the data information. Furthermore, the portable device 14 may modulate a data signal directed to the integrated wireless power appliance 12 over the electromagnetic field, which may then be demodulated and received by the integrated wireless power appliance 12. The data information sent between the two may include essentially any type of information.

To modulate data over the electromagnetic field, the portable device 14 may include the capability to dynamically change the load of the portable device 14. This allows the portable device 14 to vary the impedance of the secondary tank circuit 222, which the integrated wireless power appliance 12 may sense. The sensed variations in the impedance of the secondary tank circuit 222 allow communication from the portable device 14 to the integrated wireless power appliance 12. The integrated wireless power appliance 12 may essentially include the same capability. In alternative embodiments, the communication system may utilize characteristics other than impedance variations, such as variable phase shifts. For example, the integrated wireless power appliance 12 and the portable device 14 may communicate using the various systems incorporated in the inventive principles of U.S. application Ser. No. 12/652,061, which is entitled “Communication across an Inductive Link with Dynamic Load” and filed Jan. 5, 2010 by Baarman et al. and U.S. Pat. No. 7,522,878 which is entitled “Adaptive Inductive Power Supply with Communication” and issued Apr. 21, 2009, to Baarman et al.—all of which are incorporated by reference in their entirety. These embodiments allow both the integrated wireless power appliance 12 and the portable device 14 to communicate data bi-directionally while power is being transferred to the portable device 14.

In the current embodiment, the portable device 14 and the integrated wireless power appliance 12 may exchange data regarding power transfer characteristics and battery charge curves using modulation of the electromagnetic field. In addition, data transferred between the integrated wireless power appliance 12 and the portable device 14 may consist of audio information from portable device 14 to the integrated wireless power appliance 12 or vice versa. The integrated wireless power appliance 12 may have the ability to decipher the audio information and play it over a speaker 242. The data transferred may also consist of time or alarm information from the integrated wireless power appliance 12 to the portable device 14 or vice versa. Such a transfer of information may be useful for setting the appropriate time and/or alarm functionality in the portable device 14 or the integrated wireless power appliance 12. For example, a traveler to a residence may have different time and/or alarm information located within their portable device 14. The communication link between the integrated wireless power appliance 12 and portable device 14 may allow the two devices to quickly correct any discrepancies with the local time at the residence, such as when a traveler arrives at a residence from another time zone.

The portable device 14 and the integrated wireless power appliance 12 may communicate with each other using various communication interfaces. Communication may be exchanged using separate receiver/transmitter circuitry or through the inductive coupling between the primary 214 and secondary 218. Communication interfaces may include at least one of transfer of data, music streaming, remote calls, speakerphone, and selective emergency calls. A music-streaming interface, for example, may allow for the portable device 14 to stream music over a wireless network from a provider and transfer the streaming music to the integrated wireless power appliance 12 for playback through the speaker 242. In alternative embodiments, the integrated wireless power appliance 12 may (1) stream music over a network and (2) play the music or transfer the music to the portable device 14. The portable device 14 may control the music selection of the integrated wireless power appliance 12.

When the portable device 14 is placed on or in proximity to the integrated wireless power appliance 12, at least one of remote calling, speakerphone, and selective emergency calling features may be activated. The features may remain activated even after the portable device 14 is removed from the integrated wireless power appliance 12. The speakerphone feature may allow a user to place the portable device 14 on the integrated wireless power appliance 12 for charging and to use the speaker 242 for voice communication with others through the portable device 14 or phone and through the integrated wireless power appliance 12. The integrated wireless power appliance 12 in some embodiments also may include a microphone to facilitate voice communication. Selective emergency calling features may allow the portable device 14 to call the appropriate emergency response call center for the geographic region around the integrated wireless power appliance 12. The integrated wireless power appliance 12 may (1) inform the portable device 14 of the appropriate emergency response call center or (2) handle or route an emergency call to the appropriate emergency response call center. For example, the integrated wireless power appliance 12 may identify that an emergency call is being requested and route the call through a local phone line so that the appropriate emergency call center is contacted.

Remote calling features also may activate when the portable device 14 is near or on the integrated wireless power appliance 12. The remote calling feature may enable redirection of calls made to the portable device 14 to a nearby telephone. Alternatively, the remote calling feature may forward calls made to a nearby telephone or the integrated wireless power appliance 12 to the portable device 14. In this way, a traveler at a temporary residence could place a portable device 14 near or on the integrated wireless power appliance 12 such that calls to a phone located in the temporary residence may forward automatically to the portable device 14.

In the current embodiment, the integrated wireless power appliance 12 may be capable of displaying information (e.g. audio playback, alarm, or time, etc) from a portable device 14 on the display 206. Additionally, the user may wirelessly communicate with the portable device 14 via the user interface 32 of the integrated wireless power appliance 12. The user interface 32 may allow the user to adjust the information being sent between the integrated wireless power appliance 12 and the portable device 14, such as audio information or time/alarm of either device. In one embodiment, the remote device may communicate appliance related commands to the integrated wireless power appliance. For example, the remote device may communicate a command to change the radio station of an integrated wireless charging clock/radio.

The above description is that of the current embodiment of the invention. Various alterations and changes can be made without departing from the spirit and broader aspects of the invention as defined in the appended claims, which are to be interpreted in accordance with the principles of patent law including the doctrine of equivalents. Any reference to claim elements in the singular, for example, using the articles “a,” “an,” “the,” or “said,” is not to be construed as limiting the element to the singular.

The embodiments of the invention in which an exclusive property or privilege is claimed are as follows:

1. An integrated clock radio for supplying inductive power to a remote device comprising:
a tank circuit capable of generating an electromagnetic field to transmit power wirelessly to the remote device;
an inverter for driving the tank circuit;
a controller coupled to the inverter, the controller being capable of controlling the supply of inductive power to the remote device; and
integrated clock radio circuitry for displaying time information and outputting audio information.

2. The integrated clock radio of claim 1, wherein the integrated clock radio is capable of being used in a temporary residence and capable of supplying inductive power to disparate devices associated with different patrons of the temporary residence.

3. The integrated clock radio of claim 1, further comprising shielding to separate the integrated clock radio circuitry from a primary coil of the tank circuit.

4. The integrated clock radio of claim 1, wherein the tank circuit includes a primary coil, the primary coil being capable of moving to closely align with a secondary coil of the remote device.

5. The integrated clock radio of claim 1, wherein the integrated clock radio is capable of supplying inductive power to a plurality of remote devices by adjusting at least one of resonant frequency, operating frequency, duty cycle, and rail voltage.

6. The integrated clock radio of claim 1, further comprising communication circuitry for bi-directional communication between the integrated clock radio and the remote device.

7. The integrated clock radio of claim 1, further comprising a sensor for sensing a characteristic of power in the tank circuit, the sensor being coupled to the controller, wherein the controller controls the supply of inductive power according to the sensed characteristic.

8. The integrated clock radio of claim 1, wherein the integrated clock radio circuitry is capable of receiving at least one of AM radio transmissions and FM radio transmissions and outputting audio information that corresponds to a selected radio station.

9. The integrated clock radio of claim 1, further comprising a charging spot on the integrated clock radio, the charging spot being associated with a primary coil in the tank circuit.

10. An integrated wireless power appliance for supplying inductive power to a portable device comprising:
a tank circuit having a primary for inductively transferring power to the portable device;
inverter circuitry coupled to the tank circuit, the inverter circuitry being capable of driving the tank circuit to produce an electromagnetic field from the tank circuit.
a controller coupled to the inverter, the controller being capable of controlling the transfer of power to the portable device;
a circuit sensor for detecting transmissions being at least one of inbound transmissions to and outbound transmissions from the portable device;
appliance circuitry for producing an output;
interference cancellation circuitry coupled to the circuit sensor and to the appliance circuitry, the interference cancellation circuitry being capable of removing components of the transmissions from the output.

11. The integrated wireless power appliance of claim 10, wherein the circuit sensor is one of (1) a dedicated antenna for receiving the transmissions or (2) an integrated component of the appliance circuitry for detecting the transmissions and receiving at least one of AM radio transmissions or FM radio transmissions.

12. The integrated wireless power appliance of claim 10, wherein the interference cancellation circuitry includes signal conditioning circuitry for receiving information from the circuit sensor and antenna information from an AM/FM antenna, the signal conditioning circuitry is capable of scaling and inverting the information from the circuit sensor.

13. The integrated wireless power appliance of claim 12, wherein the interference cancellation circuitry is capable of superimposing the scaled and inverted information with the antenna information in order to produce an output without portions of the interference caused by the transmissions.

14. The integrated wireless power appliance of claim 10, wherein the interference cancellation circuitry is capable of removing components of the transmissions from received information in the appliance circuitry, the components of the transmissions are removed before demodulating the received information.

15. The integrated wireless power appliance of claim 10, wherein the transmissions include at least one of GSM, CDMA, 3G, 4G, and WiMax.

16. The integrated wireless power appliance of claim 10, wherein the output is sound from a speaker, wherein the transmissions are removed from the output to produce sound without interference.

17. A method for removing interference from an output of an integrated wireless power appliance, the integrated wireless power appliance is capable of supplying inductive power to a remote device, the method comprising the steps of:
applying power to a tank circuit within the integrated wireless power appliance;
establishing an inductive coupling between the integrated wireless power appliance and the remote device;
producing the output from the integrated wireless power appliance;
detecting transmissions being at least one of inbound transmissions to or outbound transmissions from the remote device;
based on said detecting, removing components of the transmissions from the output of the integrated wireless power appliance.

18. The method of claim 17 further comprising the step of receiving at least one of AM radio transmissions and FM radio transmissions.

19. The method of claim 17 wherein said removing step is further defined as scaling and inverting the detected transmissions.

20. The method of claim 19 wherein said removing step is further defined as combining the scaled and inverted transmissions with the output in order to remove portions of interference caused by the transmissions.

21. The method of claim 17 wherein said removing step is further defined as removing the components of the transmissions from the output before demodulating the output.

22. The method of claim 17 wherein the transmissions include at least one of GSM, CDMA, 3G, 4G, and WiMax.

23. The method of claim 17 wherein the output is sound from a speaker.

24. An integrated wireless power appliance comprising:
a tank circuit having a primary capable of generating an electromagnetic field for inductively coupling with a remote device;
a controller for controlling power transfer to the remote device via the inductive coupling;
appliance circuitry for performing functions of the integrated wireless power appliance;
a housing enclosing the appliance circuitry; and
a platform enclosing the primary and extending from the housing.

25. The integrated wireless power appliance of claim 24, wherein the platform retracts into the housing.

26. The integrated wireless power appliance of claim 24, further comprising a charging spot associated with the primary, wherein the charging spot covers a portion of the platform.

27. The integrated wireless power appliance of claim 24, wherein the platform includes a supporting structure to buttress the housing above the platform.

28. The integrated wireless power appliance of claim 24, further comprising additional platforms extending from the housing, each platform including an additional primary and an associated charging spot.
